(19) United States
(12) Patent Application Publication
(10) Pub. No.: US 2011/0173001 A1
(43) Pub. Date: Jul. 14, 2011

(54) SMS MESSAGING WITH VOICE SYNTHESIS AND RECOGNITION

(75) Inventors: Edward Thomas Guy, III, Chatham, NJ (US); Carl S. Ford, Boca Raton, FL (US)

(73) Assignee: CLEVERSPOKE, INC, Chatham, NJ (US)

(21) Appl. No.: 12/983,946

(22) Filed: Jan. 4, 2011

Related U.S. Application Data
(60) Provisional application No. 61/294,834, filed on Jan. 14, 2010.

(51) Int. Cl. G10L 13/02; H04W 4/14

(52) U.S. Cl. 704/246; 455/466; 704/E13.011

(57) ABSTRACT

When a subscriber's phone is sent a SMS message from any other Public Switch Telephone Network user, a voice call to the subscriber's phone is placed, and upon answering, the SMS message is translated into speech. A jargon translator is employed to convert SMS language into corresponding words. Once the message has been played, the subscriber receiving it may verbally request the opportunity to send a reply to the message by audibly speaking a response. The response is matched against an internal phrasebook to accurately transcribe the message. Transcription performance is improved by allowing each subscriber to provide a personal phrasebook which is combined with the internal one. However, if the spoken message is complex or not recognized, the message can be automatically relayed to a human agent for manual transcription.

### RELATED U.S. APPLICATION DATE

Provisional application No. 61/294,834 filed on Jan. 13, 2010.

### TECHNICAL FIELD

The invention relates to telecommunications, and in particular to an enhanced text messenger in a telecommunications network. More particularly, the problems of delivering text messages that may contain jargon when visually impaired and inaccurate transcription of voice input into text messages are specifically addressed.

### BACKGROUND INFORMATION

Mobile networks such as Global System for Mobile communications (GSM) provide Short Message Service (SMS) which permits mobile phone subscribers to exchange text messages using wireless terminals. It has become a popular and useful communications mechanism that has become the de facto means of mobile communication for many. It has the advantage of being concise, quick, and non-intrusive. Multi-taskers can send and process texts while in meetings, while on a train, or even while in a car. However, texting is extremely dangerous in some circumstances, such as while driving. Texting is also difficult to use when visually impaired and when converted to synthesized voice contains jargon that is not pronounceable. There have been numerous attempts to address portions of these problems.

U.S. Pat. No. 5,950,123 issued Sep. 7, 1999 to Schwelb, et al., and entitled CELLULAR TELEPHONE NETWORK SUPPORT OF AUDIBLE INFORMATION DELIVERY TO VISUALLY IMPAIRED SUBSCRIBERS describes a method to deliver various textual inputs including geographic, network messages, and SMS but it does not provide for any interactive response nor a means to present any jargon in the message in an understandable manner.

U.S. Pat. No. 6,934,552 issued Aug. 23, 2005 to Holley, et al., and entitled METHOD TO SELECT AND SEND TEXT MESSAGES WITH A MOBILE describes a method for verbally identifying a phrase from a group consisting system and user defined phrases with optional variable sections and subsequently using the selected phrase, with any manual edits, to a remote user via SMS. While this technique improves upon speech recognition, it is not suitable while visually impaired nor employing non-text capable devices because the method requires visual confirmation and manual sending of message.

U.S. Pat. No. 7,103,548 issued Sep. 6, 2006 to Squibbs, et al., and entitled AUDIO-FORM PRESENTATION OF TEXT MESSAGES describes a system for augmenting text-driven voice synthesis with various background sounds, sound effects, as well as providing selection among various voice options but does not address jargon or voice input.

U.S. Pat. No. 6,990,180 issued Jan. 24, 2006 to Vuori and entitled SHORT VOICE MESSAGE (SVM) SERVICE METHOD, APPARATUS AND SYSTEM describes a mechanism for voice input and audio output of short messages with an functional result, form the subscribers perspective, that is very much like SMS, however, there is no functionality to establish a response by the receiving party.

U.S. Pat. No. 7,526,073 issued Apr. 28, 2009 to Romeo, et al., and entitled IVR TO SMS TEXT MESSENGER describes a system for the vocal input and audible receipt of SMS text messages, however it but does not address the interpretation of jargon or text abbreviations, provide any method to improve speech recognition, provide for dictation of message s that are not recognized, and maintain nuances, stress, intonation, and precise word choices.

U.S. Pat. No. 7,310,329 issued Dec. 18, 2007 to Vieri, et al., and entitled SYSTEM FOR SENDING TEXT MESSAGES CONVERTED INTO SPEECH THROUGH AN INTERNET CONNECTION TO A TELEPHONE AND METHOD FOR RUNNING IT describes a system that facilitates the transmission of textual and prerecorded audio communication to a normal telephone from the internet. While it does provide for the capture and recording of a DTMF (the dual tone multi-frequency sounds used to signal digits to the phone service provider on an ordinary telephone's touch keys) or recorded audio response that is stored on the server or sent by email, it does not provide for general purpose or interactive messaging between users, a means to send textual SMS, nor a speech recognition function.

US Publication Number 20080059152 published Mar. 6, 2008 to Fridman, et al., and entitled SYSTEM AND METHOD FOR HANDLING JARGON IN COMMUNICATION SYSTEMS describes the translation of jargon and “emoticons” into ordinary language between text-based communication system, but does not describe an IVR-based creation nor synthesized voice solution of the present invention.

U.S. Pat. No. 7,583,974 issued Sep. 1, 2009 to Benco, et al., and entitled SMS MESSAGING WITH SPEECH-TO-TEXT AND TEXT-TO-SPEECH CONVERSION describes a Mobile Switching Center (MSC) based system that provides for SMS to be delivered in audible form and entered vocally by the user after requesting the conversion service and the mobile handset checking the subscription status and then relaying the message to the Voice Recognition module. However, it does not address the interpretation of jargon or text abbreviations, provide any method to improve speech recognition, provide for dictation of message s that are not recognized, and maintain nuances, stress, intonation, and precise word choices. Furthermore requires a user action to invoke conversion.

The main problem with fully automated approaches to these problems is that either the vocabulary and grammar are very limited or the recognition rates are too low. This is due to several factors including that the common vocabulary and grammar of the subscribers is likely different than the original programming. Furthermore, text messages often use abbreviations that cannot be read directly without expansion.

The prior art does not include any system for exchanging SMS and vocal messages that
makes the ‘SMS Language’ understandable when presented audibly, or
overcomes limitations in grammar and vocabulary that is inherent in general purpose speech recognition, or
can convert audio messages into text when automated conversion means are unsuccessful, or
maintains nuances, stress, intonation, and precise word choices when transmitted between two users.

### BRIEF SUMMARY OF THE INVENTION

It is an objective of the invention, through one or more of its various aspects and embodiments, to find a remedy for these problems and to provide an improved method to originate and terminate text messages in audio and verbal form. The solution combines various techniques which have not been previously suggested and the resulting synergy produces a system that provides greater utility to the users. The present invention is well suited for use while visually impaired.

According to one aspect of the present invention a method and system to process text messages destined for a user consisting of the following illustrative steps is provided:
Analyzing the message for jargon or “SMS Language” and replacing instances of such jargon with suitable replacements, e.g., “TTYL” would be replaced with a more meaningful “talk to you later”.
Establishing a voice (call) channel by any means to the user.
When answered, connecting a text-to-speech (TTS) component to the voice channel and causing the TTS component to synthesize voice representing the processed text message.

Furthermore, according to another aspect of the present invention, the user may vocally respond to the incoming text message by the following illustrative steps:
After delivering a message, the system will prompt the user for a command.
A Speech-To-Text engine is attached to the channel with system and user specific grammars available. This technique overcomes limitations in general purpose speech recognition by allowing personal extension to the system grammar.
The user vocally states the command to reply to the message followed by the words to be sent.
The command utterances are recorded and analyzed against the loaded grammar and a matching score is generated.
If the matching score is within a configured range and the Voice Recognition Module suggests a matching phrase, the system will prompt the user to confirm the command.
If the matching score is below a threshold, the system will prompt the user to use the transcription service. If selected, the recorded utterances will be sent to a human agent and, after listening to the recorded utterances, they will enter the text and send it to the intended destination.
If the match is confirmed or the matching score sufficiently high, the converted text will be sent as an SMS to the recipient.

According to another aspect of the present invention, the user may also initial the creation and sending of an SMS text message by establishing a voice (call) channel to the system.

According to another aspect of the present invention, if both the sending user and the receiving user have terminals that are enhanced by this invention, the nuances, stresses, intonations, and precise word choices are maintained by recording the original vocal input to the Voice Recognition Module processor and delivering it directly to the receiving user instead of transmitting synthesized voice.

### BRIEF DESCRIPTION OF THE DRAWINGS

The foregoing summary, as well as the following detailed description, will be better understood when read in conjunction with the appended drawings. For the purpose of illustrating the invention, there is shown in the drawings, embodiments which are presently preferred, it being understood, however, that this invention is not limited to the specific methods and instrumentalities disclosed. In the drawings:

FIG. 1 is schematic illustration of a telecommunication network that is enhanced by the present invention.

FIG. 2 is call flow diagram providing SMS message delivery from the PSTN, user interaction, and response to the original sender in accordance with the principles of the present invention.

FIG. 3 is a call flow diagram providing alternative user interactions resulting in a human agent-based message transcription, and response to the original sender in accordance with the principles of the present invention.

FIG. 4 is call flow diagram providing alternative user interactions wherein both sending and receiving users are using mobile handsets enhanced by the invention in accordance with the principles of the present invention.

### DETAILS OF THE INVENTION

In view of the problems described in the prior sections, the present invention and its various embodiments advantageously addresses these issues in a manner that is evident from the description that follows. The terminology, examples, drawings, and embodiments are to aide and not intended to limit the scope of the invention.

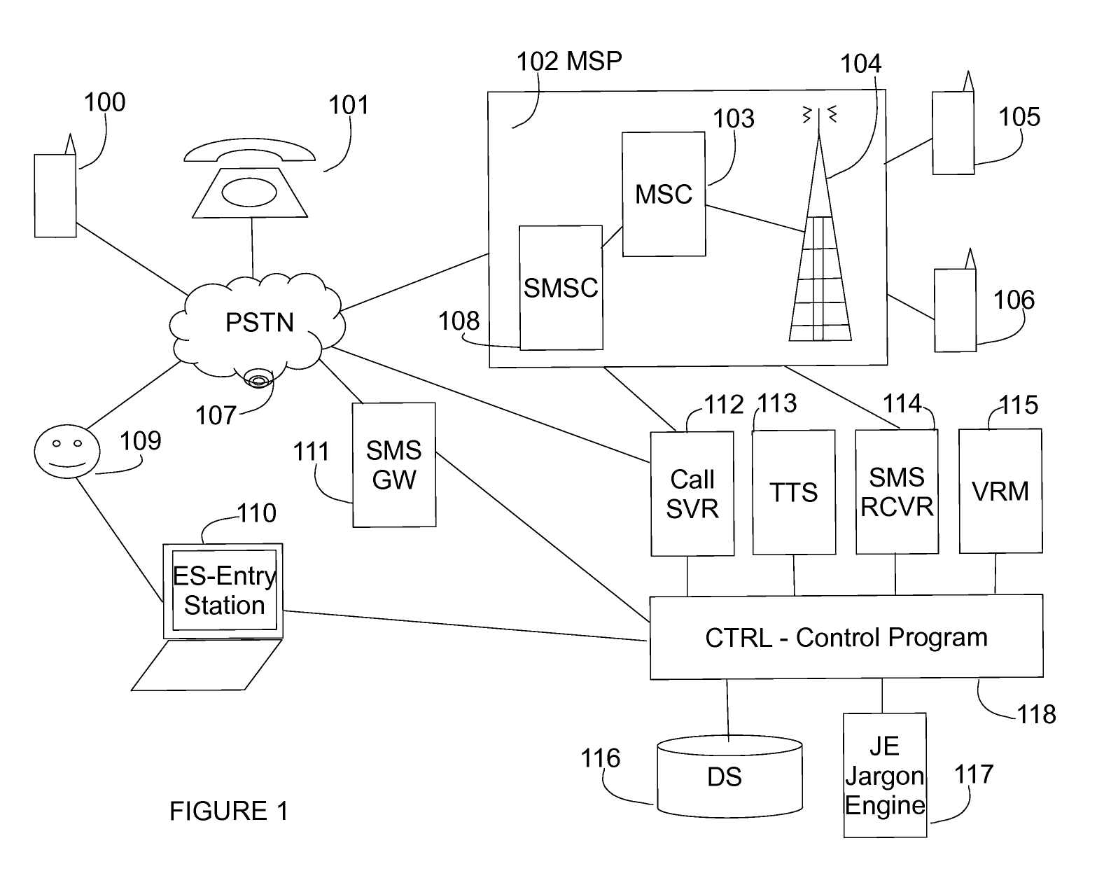

Reference is now made to FIG. 1 wherein there is shown a schematic illustration of a Mobile Service Provider (102) (MSP) that is enhanced by the present invention and various network elements which participate in aspects of the present invention.

Mobile Stations, MS (100) (105) (106), are the terminals, more commonly known as ‘cell phones’, which users employ to communicate with the network. Users may employ both text and voice communications with MS (105)(106), which are enhanced by the present invention. MS (105)(106) are linked to the Mobile Service Provider (102) via a Base Station (104). It will, of course, be understood that such a Mobile Service Provider (102) would typically be linked with a plurality of Mobile Stations (105) (106), and is to be taken as an illustration of, rather than a limitation of, the operation of the present invention. Similarly, while a Mobile Service Provider (102) is illustrated as only having one Base Station (104), it will, of course, be understood that such a Mobile Service Provider (102) would typically consist of a plurality of Base Stations (104), and is to be taken as an illustration of, rather than a limitation of, the operation of the present invention.

Mobile Service Provider (102) further supports a Mobile Switching Center, MSC, (103) which is, in essence, a traditional phone switch that was been augmented to support wireless communication. MSC (103) contains additional registers, authentication components and other components that are not shown in MSP (102) to simplify the illustration of, rather than serve as a limitation of, the operation of the present invention. It is understood by a person of ordinary skill in the art, that a Mobile Service Provider (102) typically contains many such components linked to each other by various communications methods to perform functions necessary for, for instance, call, SMS, and data services.

Mobile Service Provider (102) further supports a Short Message Service Center, SMSC, (108). SMSC (108) provides the SMS operations of a wireless network. SMSC (108) is linked to the Public Switched Telephone Network, PSTN, (107) for purposes of exchanging SMSs (not shown) with other SMSCs (not shown) on the PSTN (107). Although only one MSC (103) and one SMSC (108) are shown in Mobile Service Provider (102) to simplify the illustration, it is understood by a person of ordinary skill in the art that Mobile Service Provider (102) typically contains many such components linked to each other by various communications methods.

In the preferred embodiment, SMSC (108) is enhanced such that SMSs for users whose Mobile Stations (105) (106) have been enhanced with the present invention are directed to an SMS Receiver, SMS RCVR, (114) in addition to sending the text to the handset.

Alternate embodiments may use an SMSC substitute, e.g., as currently found in Google Voice, for processing SMS messages.

SMS Receiver (114) invokes a Control Program, CTRL, (118) which is responsible for determining and managing a sequence of functional interactions of the present invention. The interactions invoked for a particular message are driven by a plurality of inputs including, but not limited to, the SMS message, a subscriber profile retrieved from a Data Store, DS, (116) which includes subscriber specific rules for controlling a Voice Recognition Module, VRM, (115) as well as a specification for translating jargon into plain text in a JE—Jargon Engine (117). Inputs also include VRM (115) results. Alternate embodiments may obtain subscriber profiles and control information from remote systems using any of various networking techniques which are understood by a person of ordinary skill in the art.

VRM (115) is stimulated by utterances transmitted via an established Audio Channel or Call Path (not shown) from Mobile Handset (105) via Mobile Service Provider (102), through the PSTN (107), or alternatively, directly or indirectly, from MSC (103) using any of various methods which are understood by a person of ordinary skill in the art. VRM (115) may be an instance of a product such as the LUMENVOX SPEECH ENGINE, the NUANCE VOCON 3200, the NUANCE VOCON SF, IBM EMBEDDED VIAVOICE, or generally any application capable of recognizing speech operating in manner which is understood by a person of ordinary skill in the art.

JE—Jargon Engine (117) is employed to replace the “SMS Language” with plain language in order to make it more suitable for speech. Rules in the form of a dictionary for translation are received from Control Program (118) and used to process the SMS text. For example, “LOL” could be translated into “Laugh out loud” or “BCNU” into “Be seeing you.”

A TTS—Text To Speech (113) component receives commands from Control Program (118) and synthesizes human speech by assembling fragments of recorded human speech. The text to speech subsystem (113) may be embodied as a Cepstral brand text to speech processor or any similar technology generally capable of synthesizing speech operating in manner which is understood by a person of ordinary skill in the art. The synthesized speech is delivered to Mobile Handset (105) via the established Audio Channel or Call Path. In addition, recorded human voices and various other sounds may be stored in a machine-readable medium such as Data Store (116), and under direction of Control Program (118) played to the user on Mobile Station (105) via the established Audio Channel or Call Path through Call Server (112).

Call Server (112) provides signaling and control of the Audio Channel or Call Path to the Mobile Station. Call Server (112) may be any telephony processor, such as the DIGIUM ASTERISK, the PINGTEL SIPXCHANGE, FREESWITCH, or generally any application that provides the functionality of a Logic-based Call Server.

In various embodiments of the invention, an SMS Gateway, SMS GW, (111) provides a mechanism to deliver SMSs from Control Program (118) to Mobile Stations (100), (105), and (106) on the PSTN (107) or on Mobile Service Provider (102).

A Telephone (101) is a Plain Old Telephone Service (POTS) station, typically associated with fixed line service, that is not capable of text-based SMS input or output. POTS stations, together with Mobile Stations, will together hereinafter be referred to as voice terminals.

A Human Agent (109) is used to transcribe messages that were not or could not be suitably captured by VRM (115). Various embodiments perform the transcription in real time and others, by employing a recorded dictation methodology. An Audio Path may be via the PSTN in any manner which is understood by a person of ordinary skill in the art, or via a Sound Subsystem (not shown) in an ES, Entry Station (110).

Furthermore, alternative software implementations of the present invention include, but are not limited to, distributed computing, component/object distributed processing, parallel processing, or virtual machine processing. Additionally, the present invention's particular elements or components described herein may have their physical or functional features incorporated into other components, divided into distinct components, or implemented in a stand-alone manner.

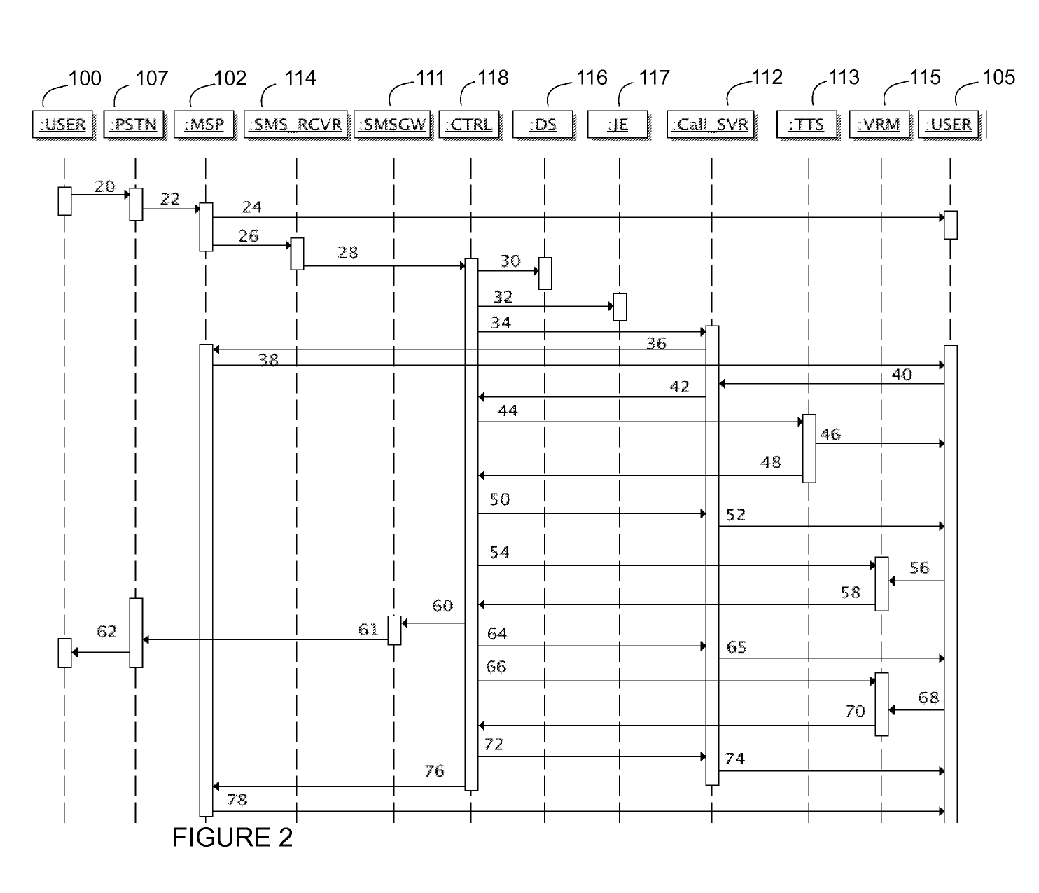

Reference is now made to FIG. 2 wherein there is shown a call flow diagram providing SMS message delivery from the PSTN, user interaction, and response to the original sender in accordance with the principles of the present invention. The vertical lines in the diagram represent components, modules, or actors in the present invention relevant to the current exemplified scenario. The horizontal arrow headed lines represent interactions, messages, or steps relevant to the current exemplified scenario.

A shown, in the preferred embodiment, a User writes a text message on Mobile Station (100) and sends it (20) to the PSTN (107) and further sends (22) to MSP, Mobile Service Provider, (102) via using any of various networking techniques which are understood by a person of ordinary skill in the art.

Alternative embodiments may create text messages on other input terminals, such as web browsers, and send them via the PSTN (107) or other means to Mobile Service Provider (102) or directly to SMS Receiver (114).

In the preferred embodiment, Mobile Service Provider (102) transmits (24) a copy of text message to Mobile Station (105) where the user may read it, allow it to remain in their inbox, or perform any of the actions available to them on Mobile Station (105). Alternative embodiments may apply various strategies to limit sending the text message to Mobile Station (105), such as not sending it if audio delivery is successful, or making it available for later retrieval.

In the preferred embodiment, Mobile Service Provider (102) transmits (26) the text message to SMS RCVR (114), and then it is transmitted (28) to Control Program (118) which then regulates, and commands other system components.

As shown, Control Program (118) interacts (30) with Data Store, DS, (116). In this preferred embodiment, the effect is to retrieve subscriber profiles including their personal grammars which enable improved speech recognition.

The next step is to process (32) the text message with JE, Jargon Engine (117). This function removes SMS Language, e.g., phrase such as “TTYL’ and replacing them with plain language, such as “talk to you later”, which is more suitable for audio.

Call Server (112) is next used to create an audio path to the User's Mobile Station (105). In the preferred embodiment, this is accomplished by establishing a voice phone call, using any of various networking techniques which are understood by a person of ordinary skill in the art, directly to (36) Mobile Service Provider (36) and then to (38) Mobile Station (105). Alternate embodiments are not limited to routing the call via the PSTN (107) or invoking an application on Mobile Station (105) and communicating via a data channel.

When Mobile Station (105) has answered (40) the voice phone call, Call Server (112) informs (42) Control Program (118) so that it may proceed with the programmed steps.

Using (44) TTS, Text-To-Speech, (113) processor, the text message is read (46) to Mobile Station (105) with its synthesized voice. Alternate embodiments may stream additional media before and after the text message. When this process step has completed, it informs (48) Control Program (118) to proceed.

Control Program (118) informs (50) Call Server (112) to prompt (52) the user of Mobile Station (105) to vocalize a command, for instance, by playing a message such as, “What would you like me to do now?”

Next, Control Program (118) informs (54) Voice Recognition Module, VRM, (115) to collect (56) audio and derive a phrase by analyzing the utterances with its internal programming guided by system and user specific grammar using any of the techniques which are understood by a person of ordinary skill in the art. The results are returned (58) to Control Program (118).

In this call flow, Voice Recognition Module (115) results indicate a strong matching score and a suitable phrase, indicating that, with a high degree of confidence, the derived text represents the spoken words. The phrase is parsed for a command and formulated into an SMS and sent (60) to SMSGW, SMS Gateway (111) into the PSTN (107) and to originator's Mobile Station (100) using any of various networking techniques which are understood by a person of ordinary skill in the art.

Next, Control Program (118) informs (64) Call Server (112) to prompt (65) Mobile Station (105)'s User to vocalize a command.

Subsequently, Control Program (118) informs (66) Voice Recognition Module, VRM, (115) to collect (68) audio and derive a phrase by analyzing the utterances with its internal programming guided by system and user specific grammar as previously performed in (54), (56), and (58). The results are returned (70) to Control Program (118).

In this call flow, Voice Recognition Module (115) results indicate a strong matching score and a suitable phrase. The phrase is parsed and Control Program (118) determines it should close the session. Control Program (118) commands (72) Call Server (112) to play (74) a closing message, for example, “Thank you for using our service.” to Mobile Station (105). Control Program (118) then tears down, or “hangs up”, (76), (78) the call or audio channel.

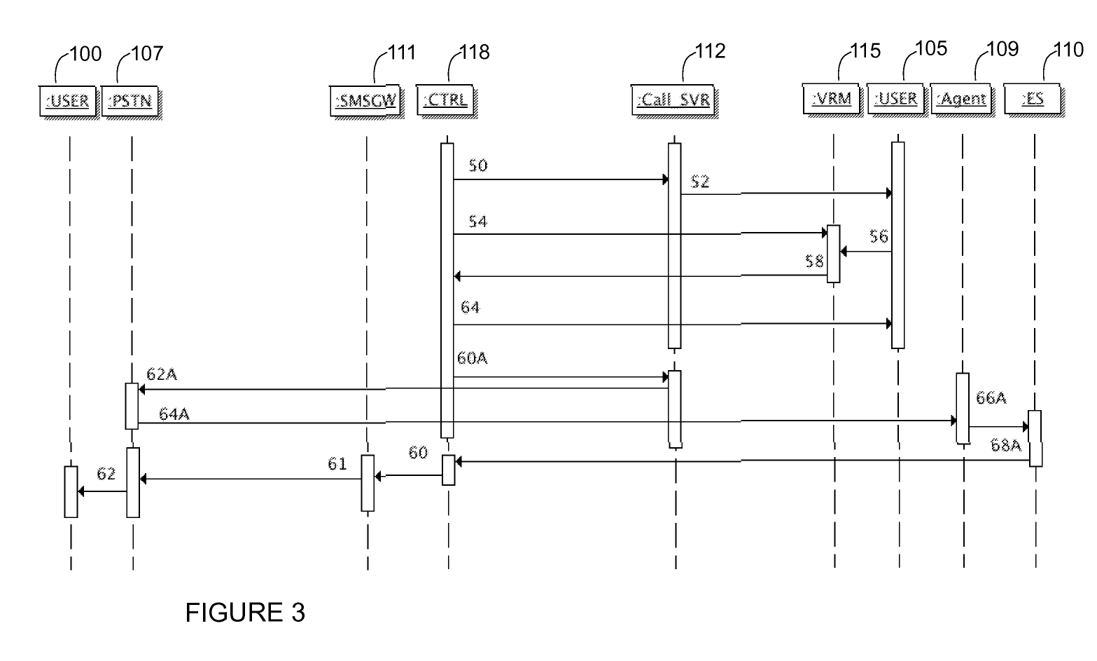

Reference is now made to FIG. 3 wherein there is shown a call flow diagram providing alternative user interactions resulting in a human agent-based message transcription, and response to the original sender in accordance with the principles of the present invention. This feature is typically invoked when the desired message is too complex to be accurately converted by Voice Recognition Module (115). For illustration purposes, this figure only shows a portion of a session that involves transcription; Call setup, tear-down and initial delivery of a text message are shown in the previous figure.

This scenario starts after a text message has been synthetically read to the user, or in alternative embodiments, after the user initiates a session and specified a recipient for the text message.

Control Program (118) informs (50) Call Server (112) to prompt (52) Mobile Station (105)'s User to vocalize a command, for instance, by playing a message such as, “What would you like me to do now?”

Next, Control Program (118) informs (54) Voice Recognition Module, VRM, (115) to collect (56) audio and derive a phrase by analyzing the utterances with its internal programming guided by system and user specific grammar as performed in the prior example. The results are returned (58) to Control Program (118).

In the preferred embodiment, Control Program (118) parses the input and determines that the previous message was to be transcribed with the assistance of a Human Agent (109). Alternative embodiments examine a matching score from Voice Recognition Module (115) and if the score is too low, the User is prompted to see if the message should be human translated.

Further in accord with the preferred embodiment, Mobile Station (105) is prompted (64) for the next command in the sequence, while the transcription process continues asynchronously without User involvement. The Mobile Station (105) interaction continues as exemplified in FIG. 2.

In the preferred embodiment, Control Program (118) instructs (60A) Call Server (112) to initiate (62A) a audio connection (voice phone call) to Human Agent (109) through (64A) the PSTN (107). The connection may be implemented with, but not limited to, PSTN, or Voice Over Internet Protocol (VoIP) technology with any of various techniques which are understood by a person of ordinary skill in the art.

Once this audio connection is established, Human Agent (109) hears the recorded message from (58), along with identifying information, then enters this identifying information and equivalent text into Entry Station (110).

Alternate embodiments deliver the recorded message to the Human Agent (109) using email or by displaying an entry on a web page employing any of various techniques which are understood by a person of ordinary skill in the art. To aide in transcription, the ability to repeat and listen to any portion of the recorded message is provided.

Further in accord with the preferred embodiment, Entry Station (110) transmits (68A) the text and identifying information to Control Program (118) which formulates a text message and transmits it to Mobile Station (100) via SMS Gateway (111) and the PSTN (107) as exemplified in (60), (61), and (62) of FIG. 2.

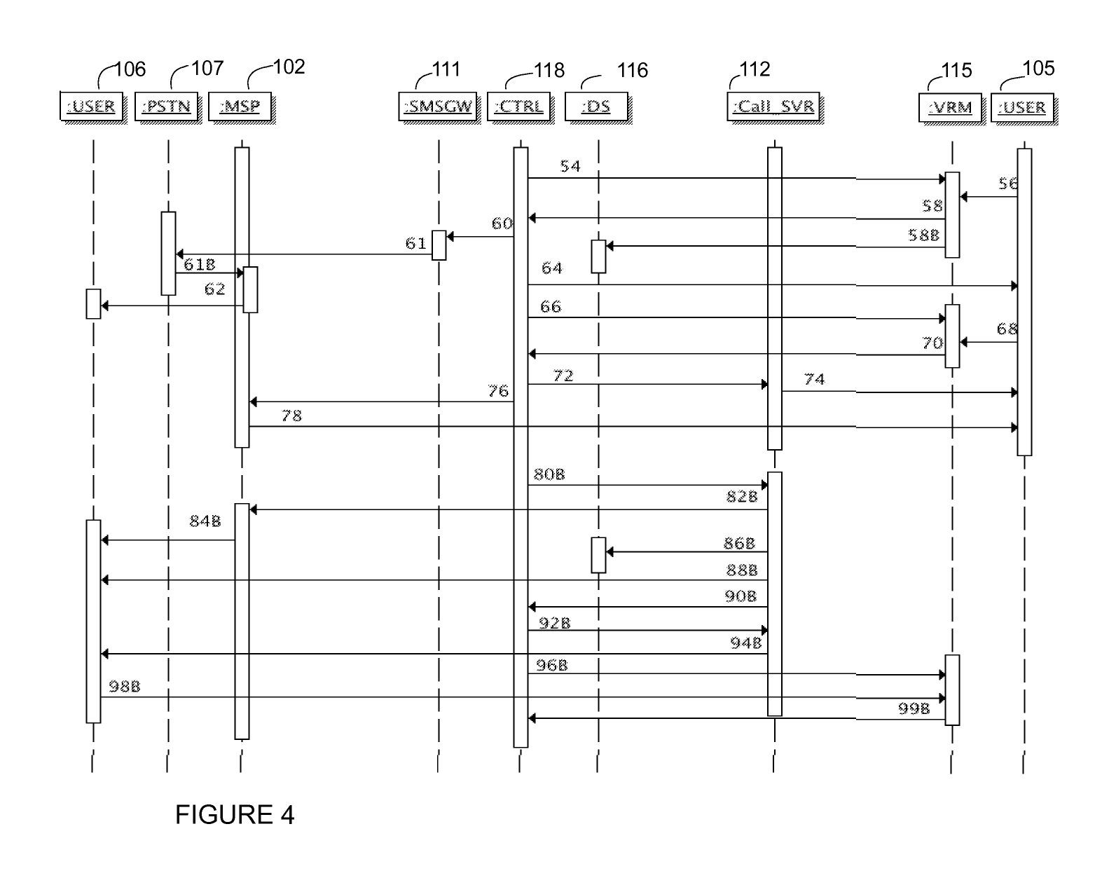

Reference is now made to FIG. 4 wherein there is shown a call flow diagram providing alternative user interactions wherein both sending and receiving Mobile Stations (105) (106) are using mobile handsets enhanced by the invention in accordance with the principles of the present invention.

Interactions (54) through (78) show the collection of a text message as exemplified in FIG. 2. Note that since Mobile Station (106) is associated with the same Mobile Service Provider (102), the utterances are stored (58B) in Data Store (116) and the text message is processed (61B) by Mobile Service Provider (102) as well using any of a variety of techniques which are understood by a person of ordinary skill in the art.

In the preferred embodiment users of Mobile Station (105) are not informed that Mobile Station (106) is also enhanced by the present invention. Alternate embodiments may inform users of Mobile Station (105) that the intended destination is enhanced by the present invention.

In further accord with the present invention, Control Program (118) commands (80B) Call Server (112) to create (82B) a voice channel (call) to Mobile Station (106) via (84B) Mobile Service Provider (102). Once the voice channel is established, the Call Server (112) retrieves (86B) the recorded utterances which were stored in step (58B) from Data Store (116) and directs (88B) the recording to the user through the audio channel.

Subsequently, Call Server (112) informs (90B) Control Program (118) that the recorded message has been delivered and Control Program (118) instructs (92B) Call Server (112) to prompt (94B) Mobile Station (106) user for input. Next, Control Program (118) informs (96B) Voice Recognition Module, VRM, (115) to collect (98B) audio and derive a phrase by analyzing the utterances with its internal programming guided by system and user specific grammar using any of the techniques which are understood by persons of ordinary skill in the art. The results are returned (99B) to Control Program (118).

The Mobile Station (106) user and the system continue to interact (not shown) as exemplified in FIG. 2.

Alternate embodiments of the present invention's particular elements or components described herein may have their functionality implemented on Mobile Station (105), Mobile Service Provider (102), or Internet-based using any of various techniques which are understood by a person of ordinary skill in the art.

1. An apparatus that provides a voice interaction service with SMS and text messages for subscribing voice terminals comprising:
a) a means for processing SMS messages sent to the subscribing mobile stations;
b) a SMS receiver which receives the processed SMS messages;
c) a data store which stores profiles for subscribers to the service, including their personal grammar and syntax preferences, recorded human voices and other sounds, and rules for controlling a voice recognition module;
d) a jargon engine which recognizes jargon such as abbreviations commonly used in text messaging and replaces such jargon with plain language;
e) a text-to-speech module, which assembles fragments of recorded human speech;
f) a voice recognition module, which is activated by subscribers' speech;
g) a call server which provides a means of sending a synthesized voice message or other messages to the subscribing mobile station through the signaling and control of an audio channel or call path; and
h) a control program connected to the SMS receiver, the data store, the jargon engine, the text-to-speech module, the call server and the voice recognition module, for (i) receiving a SMS message from the SMS Receiver; (ii) analyzing and processing the SMS message by querying the data store subscriber profile record for translating jargon into plain text in the jargon engine; iii) using the results of the query to replace any jargon with plain language via the jargon engine; (iv) establishing a connection with the subscribing mobile station through the call server; v) using the text-to-speech processor, once the subscribing mobile station answers the call, to read the processed message with the synthesized voice; (vi) following the conversion of the text to speech, informing the call server to prompt the subscriber to vocalize a command; (vii) informing the voice recognition module to collect any utterances received from the subscriber; viii) further analyzing the received utterances by querying the data store record of the subscriber-specific rules for personal grammar and syntax preferences, to derive text therefrom; and ix) receiving results from the voice recognition module indicating whether the results should be converted into an SMS message via the text to speech engine for transmission to its intended recipient or whether the results should be sent to a human agent for further processing into a SMS message.

2. Apparatus of claim 1 wherein the voice terminal is a mobile station.

3. Apparatus of claim 1 wherein the voice terminal is a Plain Old Telephone Service station

4. Apparatus of claim 1 wherein the control program, after it receives the results from the voice recognition module indicating that the results should be sent to a human agent for further processing into an SMS message, prompts the subscriber to send the results to a human agent.

5. Apparatus of claim 1 wherein the control program, after it receives the results from the voice recognition module indicating that the results should be converted into an SMS message prompts the subscriber to confirm the command before it transmits the results to its intended recipient,

6. Apparatus of claim 1 wherein the control program, after it receives the results from the voice recognition module indicating that the results should be converted into an SMS message, converts the results into an SMS message via the text to speech engine for transmission to its intended recipient.

7. Apparatus of claim 1 wherein the means for processing SMS messages sent to a subscribing mobile station is a Short Message Service Center of a Mobile Service Provider that delivers the SMS messages to the SMS Receiver.

8. Apparatus of claim 1 wherein the means for processing SMS messages sent to a subscribing mobile station is via an SMSC substitute for processing SMS messages.

9. Apparatus of claim 1 wherein the subscriber profile of claim 1 also includes a subscriber-specific personal jargon dictionary for translating SMS messaging abbreviations particular to the subscriber into plain language.

10. Apparatus of claim 1 wherein the jargon engine of claim 1 also recognizes and replaces jargon specific and particular to the subscriber.

11. Apparatus of claim 1 wherein the audio channel or call path may be via the PSTN or via a Sound Subsystem in an Entry Station.

12. Apparatus of claim 1 wherein subscriber may verbally request their message to be manually transcribed by directing their utterances by any means to an agent who transcribes and enters the text message on their behalf.

13. Apparatus of claim 1 wherein the received utterances are recognized as a command to call the originator of the SMS message instead of sending a response text message.

14. Apparatus of claim 1 wherein the received utterances are recognized as a command to send an SMS message to another destination.

15. Apparatus of claim 1 wherein additional SMS messages, which arrive while the audio channel to the mobile Station is established, are audibly transmitted to the mobile station using the same audio channel.

16. Apparatus of claim 1 wherein the apparatus can be conditionally activated.

17. Apparatus of claim 14 wherein the apparatus is conditionally activated based on the time of day.

18. Apparatus of claim 1 wherein the jargon engine may process the subscriber's outgoing message and replace identified phrase with jargon.

19. Apparatus of claim 1 wherein the subscriber's utterances are audibly transmitted to the sender of the first SMS message, instead of, or in addition to, the translated text.

20. A method for providing a voice interaction service with SMS and text messages for subscribing mobile stations comprising:
a) receiving a SMS message from the SMS Receiver;
b) analyzing and processing the SMS message by querying the data store subscriber profile record for translating jargon into plain text in the jargon engine;
c) using the results of the query to replace any jargon with plain language via the jargon engine;
d) establishing a connection with the subscribing mobile station through the call server;
e) using the text-to-speech processor, once the subscribing mobile station answers the call, to read the processed message with the synthesized voice;
f) following the conversion of the text to speech, informing the call server to prompt the subscriber to vocalize a command;
g) informing the voice recognition module to collect any utterances received from the subscriber;
h) further analyzing the received utterances by querying the data store record of the subscriber-specific rules for personal grammar and syntax preferences, to derive text therefrom; and
i) receiving results from the voice recognition module indicating whether the results should be converted into an SMS message via the text to speech engine for transmission to its intended recipient or whether the results should be sent to a human agent for further processing into a SMS message.
